(19) United States
(12) Patent Application Publication
(10) Pub. No.: US 2025/0282302 A1
(43) Pub. Date: Sep. 11, 2025

(54) ROTATABLE VEHICLE DISPLAY SYSTEM POWERED BY A MOTOR HAVING A FLEXIBLE CONNECTION TO THE DISPLAY SYSTEM

(71) Applicant: Fisker Inc., Manhattan Beach, CA (US)

(72) Inventor: Stephen Halonen, Manhattan Beach, CA (US)

(21) Appl. No.: 18/600,500

(22) Filed: Mar. 8, 2024

(51) Int. Cl. B60R 11/02; B60R 11/00

(52) U.S. Cl. CPC B60R 11/0235; B60R 2011/0007; B60R 2011/0087; B60R 2011/0092

(57) ABSTRACT

The technology disclosed herein enables display screen rotation without compromising passenger impact safety. In a particular example, an apparatus includes a display system including a display screen on a front side of the display system and a mounting interface on a rear side of the display system. The apparatus also includes a bracket to which the mounting interface attaches and a flexible mechanical power transmitter connecting a power output of a motor to a power input at the mounting interface. The flexible mechanical power transmitter rotates the display system around a screen-rotation axis. The motor includes the power output, and the power output rotates around a motor-rotation axis different from the screen-rotation axis.

### BACKGROUND

Center display screens in modern vehicles have evolved significantly over the years. These screens, often referred to as infotainment systems, serve as the central hub for various functions within the vehicle. From controlling climate settings and audio playback to providing navigation assistance, these displays enhance the driving experience. However, as these screens grow larger and more prominent in a vehicle's interior, the screens' involvement in passenger safety becomes an important factor to consider when designing a vehicle.

Government regulations have long provided safety standards that need to be met before a vehicle can be sold. Those safety standards include standards for passenger impact absorption by components of the vehicle's interior. Traditionally, those impact standards may describe how materials from which a vehicle's steering wheel or dashboard should be selected to mitigate the impact forces felt by a passenger should their head, or other body part, come into contact with the steering wheel or dashboard. In modern vehicles, the regulations may now apply to display screens, as passengers may also impact display screens when involved in an accident.

### SUMMARY

The technology disclosed herein enables display screen rotation without compromising passenger impact safety. In a particular example, an apparatus includes a display system including a display screen on a front side of the display system and a mounting interface on a rear side of the display system. The apparatus also includes a bracket to which the mounting interface attaches and a flexible mechanical power transmitter connecting a power output of a motor to a power input at the mounting interface. The flexible mechanical power transmitter rotates the display system around a screen-rotation axis. The motor includes the power output, and the power output rotates around a motor-rotation axis different from the screen-rotation axis.

In another example, a method includes transmitting, from a vehicle compute unit, a rotation signal directing a motor to rotate the display system. The method also includes, at the motor, in response to the rotation signal, activating the motor connected to a flexible mechanical power transmitter to rotate the display system around a screen-rotation axis. Power output of the motor rotates around a motor-rotation axis different from the screen-rotation axis.

### BRIEF DESCRIPTION OF THE DRAWINGS

FIG. 1 illustrates a vehicle having a rotatable display system powered by a motor flexibly connected to the display system.

FIG. 2 illustrates implementation for rotating a display system using a motor flexibly connected to the display system.

FIG. 3 illustrates an operational scenario for a display system rotatable using a motor flexibly connected to the display system.

FIG. 4 illustrates implementation for rotating a display system using a motor flexibly connected to the display system.

FIG. 5 illustrates a chain drive for rotating a display system using a motor flexibly connected to the display system.

FIG. 6 illustrates an operational scenario for a display system rotatable using a motor flexibly connected to the display system.

FIG. 7 illustrates a mounting connection for rotating a display system using a motor flexibly connected to the display system.

FIG. 8 illustrates implementation for rotating a display system using a motor flexibly connected to the display system.

FIG. 9 illustrates an operation to rotate a display system using a motor flexibly connected to the display system.

FIG. 10 illustrates a computing system for rotating a display system using a motor flexibly connected to the display system.

### DETAILED DESCRIPTION

Vehicle interiors are typically designed with safety in mind whether due to government regulations or general best practices. For instance, a dash and steering wheel of a vehicle may be designed in a manner to either absorb or, otherwise, reduce the force of a user impacting those parts of the vehicle. With larger displays becoming more prevalent, the chance of a user impacting a display is also greater. The display system described herein is affixed to a mounting bracket designed to collapse in a manner that absorbs impact forces (e.g., forces from a passenger's head or body during a front-end collision of the vehicle).

Moreover, the display apparatus reduces the impact force to a user while also providing a rotation mechanism for rotating the display. A rotation mechanism may be beneficial for displays of modern infotainment systems due to the new media types the systems are capable of presenting. For example, when presenting a movie in a widescreen format it may be preferable for the display to have a landscape orientation. In contrast, a portrait orientation may be preferable when driving and presenting a user interface into more typical vehicle functions (e.g., HVAC, radio, navigation, etc.). A rotation mechanism may rotate the display into either orientation to achieve the benefits of both orientations for a vehicle display. Importantly, the rotation mechanism described below does not sacrifice the impact absorption capabilities of the display system. A typical rigid drive shaft between motor and display would inhibit the display system from collapsing as designed. Similarly, including a rotation motor directly on the back of the display may add too much mass for the system to absorb an impact properly or the volume taken up by the motor may block the display system from collapsing in the desired manner.

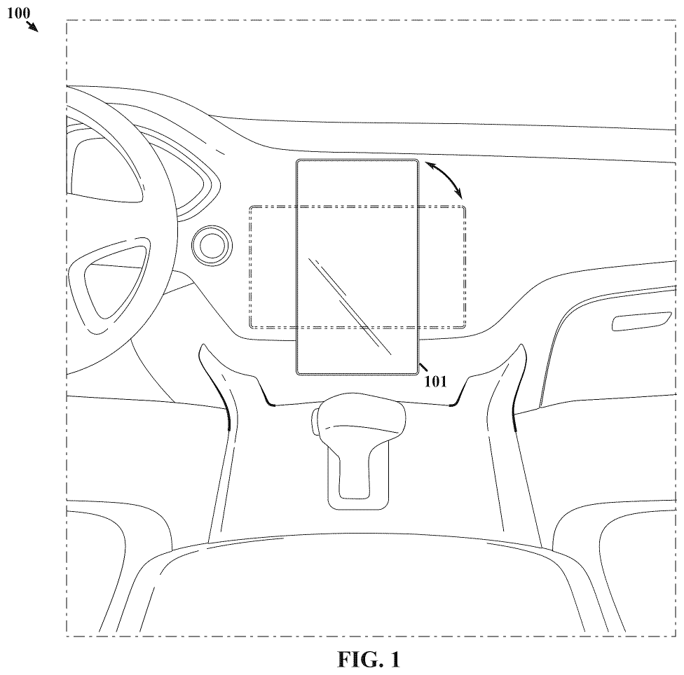

FIG. 1 illustrates vehicle 100 having a rotatable display system powered by a motor flexibly connected to the display system. Vehicle 100 is depicted from the inside facing forwards. Vehicle 100 includes display system 101 as well as other common interior components (e.g., steering wheel, dash, passenger seats, gear selector, etc.). Display system 101 is rotatable 90 degrees to achieve either a portrait (solid line) or landscape (dashed line) orientation. Other examples may allow display system 101 to rotate more than the 90 degrees shown in this example. Vehicle 100 is merely an example design for a vehicle interior. As such, the components included in vehicle 100 may differ. Likewise, while shown as a passenger vehicle, vehicle 100 may be a car, truck, van, tractor, boat, airplane, wheelchair, or any other type of vehicle into which a display may be installed. Likewise, while illustrated as a center display in the front of vehicle 100's interior, display system 101 may be installed elsewhere in vehicle 100, such as behind the front seats for viewing by rear passengers of vehicle 100. A display system like display system 101 may also be useful in non-vehicular applications where impacts may occur to a rotating display system and absorbing those impacts would be beneficial. Bracket 205 described below would be mounted to a different structure in those applications than the vehicular examples presented herein.

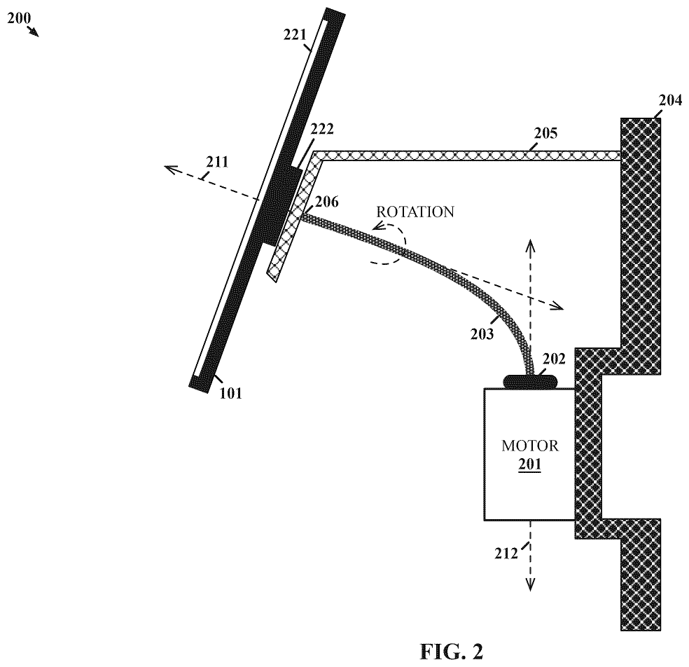

FIG. 2 illustrates implementation 200 for rotating a display system using a motor flexibly connected to the display system. Implementation 200 includes display system 101, motor 201, power output 202, flexible shaft 203, cross-vehicle beam 204, bracket 205, and power input 206, which are shown from a side profile. It should be understood that the shape of the components in implementation 200 is merely exemplary. Display system 101 includes display screen 221 and mounting interface 222. Mounting interface 222 may be part of a housing for display screen 221 in display system 101. Display screen 221 may be a Liquid Crystal Display (LCD), Light-Emitting Diode (LED) display, Organic Light-Emitting Diode (OLED) display, or some other type of display technology. Mounting interface 222 attaches display system 101 to bracket 205. Mounting interface 222 may be attached to bracket 205 using a threaded mechanism, tabs, clips, screws, nuts and bolts, rivets, or some other type of fastener-including combinations thereof. Mounting interface 222 may include one or more bearings enabling display system 101 to rotate around display rotation axis 211, which runs perpendicular to the plane where display system 101 and bracket 205 meet. In some examples, the one or more bearings may be included in bracket 205 where mounting interface 222 connects to bracket 205.

Motor 201 is an electric motor including power output 202. Rotational power is provided by motor 201 via power output 202, which rotates around motor rotation axis 212. Motor 201 may be a direct current or alternating current motor. Motor 201 may include one or more bearings, rotor, stator, armature, magnets, brushes, or some other type of component for converting electrical power into mechanical power-including combinations thereof. Flexible shaft 203 is connected from power output 202 to power input 206. Flexible shaft 203 may be a braided wire manufactured by braiding together multiple strands of wire, such as music wire, to produce a durable yet flexible mechanical power transmitter. Other examples may use different types of mechanical power transmitter, such as a chain or a belt, to transmit the rotation of power output 202 by motor 201 to power input 206. While power output 202 is shown protruding from motor 201, power output 202 in other examples may be flush with or recessed within the housing of motor 201. Similarly, while power input 206 is not shown protruding from motor 201, as power input 206 may be flush with or recessed into bracket 205 or mounting interface 222, power input 206 may protrude in other examples such that power input 206 can be viewed in implementation 200. Flexible shaft 203 may be connected to power output 202 and power input 206 using clamps at each end, pins or screws through power input 206 at each end, a keyed connector, or come other type of coupling that prevents power input 206 from releasing from power output 202 or power input 206—including combinations thereof.

In this example, bracket 205 is affixed to cross-vehicle beam 204 and motor 201 is mounted to cross-vehicle beam 204. Cross-vehicle beam 204 spans vehicle 100 from side to side. Cross-vehicle beam 204 may be located behind a dashboard of vehicle 100 when viewed from the passenger compartment of vehicle 100. Other components of vehicle 100 may also be connected to cross-vehicle beam 204. While motor 201 is directly mounted to cross-vehicle beam 204 is this example, motor 201 may be mounted to a bracket attached to cross-vehicle beam 204 or may be mounted elsewhere in vehicle 100 as long as motor 201 can still rotate display system 101 via flexible shaft 203. Additionally, motor 201 is positioned such that motor 201 does not interfere with movement of display system 101 (at least for a predetermined distance) should an impact to display system 101 cause bracket 205 to deform allowing display system 101 to move towards cross-vehicle beam 204. Display rotation axis 211 and motor rotation axis 212 are not parallel to each other in this example but may be parallel in other examples. In other examples, bracket 205 may be affixed to some other part of vehicle 100's structure or may be integrated into some other vehicle component rather than existing as an independent part. In those examples, vehicle 100 may not include cross-vehicle beam 204 or cross-vehicle beam 204 may not be positioned in a location conducive to attaching bracket 205. In a particular example, bracket 205 may be integrated into a structure for vehicle 100's instrument panel.

While not shown, implementation 200 may also include one or more wires providing electrical power to display system 101 and enabling exchange of communications with display system 101 (e.g., to send a graphical display signal from a vehicle compute unit to display a user interface on display system 101 or receive user input via touchscreen input received from a passenger of vehicle 100).

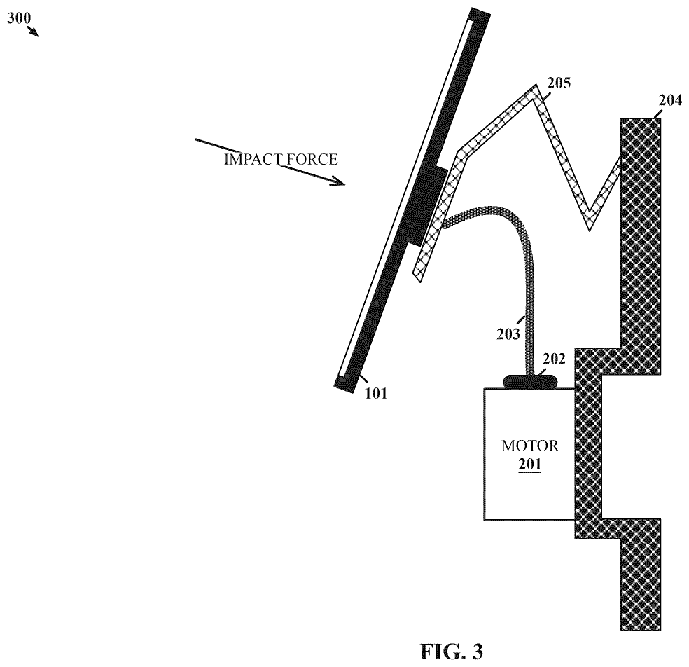

FIG. 3 illustrates operational scenario 300 for a display system rotatable using a motor flexibly connected to the display system. Operational scenario 300 is an example of what may happen with the components of implementation 200 should an impact force be applied to display system 101. The direction of the impact force on display system 101 is substantially towards cross-vehicle beam 204, as the impact force may be coming from an impact of a passenger of vehicle 100 on display system 101. For example, if vehicle 100 is in a front-end collision, the collision may cause a passenger's head to impact display system 101. The chances of injury are likely greater if display system 101 did not move and cushion the impact in response to receiving the impact force.

Bracket 205, in this example, is designed to collapse, crush, or otherwise deform upon an impact force being transmitted to bracket 205 from display system 101. The amount of force absorbed by display system 101 in conjunction with bracket 205 may be linear or progressive. The shape of bracket 205 may be dependent upon an amount of force intended to be absorbed, packaging considerations within vehicle 100, a material (e.g., metal, plastic, etc.) from which bracket 205 is constructed, or some other characteristic. Given that motor 201 is not mounted to bracket 205, bracket 205 may be a bracket originally designed to handle non-rotatable display systems. The ability to use existing bracket designs, which are already shown to comply with impact safety standards/regulations, for a rotating display system may result in cost savings for a manufacturer of vehicle 100 versus having to design a new bracket. Similarly, a manufacturer of vehicle 100 may be able to offer the option of installing a rotating display system or a static display system while using the same bracket for both.

In operational scenario 300, bracket 205 has bent at multiple locations to absorb the impact force applied to display system 101. Space still remains between display system 101 and motor 201 but the distance between display system 101 and motor 201 is smaller than the distance prior to impact, as shown in implementation 200. The state of bracket 205 in operational scenario 300 is merely an example of how bracket 205 may crush in response to the impact force. As noted above, bracket 205 may take different shapes and be made of different materials, which may result in different reactions by bracket 205 to receiving the impact force. The flexibility of flexible shaft 203 enables flexible shaft 203 to bend when display system 101 moves with the collapsing of bracket 205 due to the impact force. Preferably, the flexibility of flexible shaft 203 is enough such that the presence of flexible shaft 203 has a negligible effect on impact absorption characteristics of bracket 205. Likewise, motor 201 is positioned such that motor 201 does not interfere with movement of display system 101 or bracket 205 for at least a predefined amount of movement when an impact for is experienced by display system 101. The amount of movement may be based on safety regulations or other passenger safety requirements. If flexible shaft 203 had been a rigid shaft (with motor 201 positioned to accommodate the rigid shaft), the rigid shaft may not yield to the impact force, which prevents display system 101 from collapsing as shown.

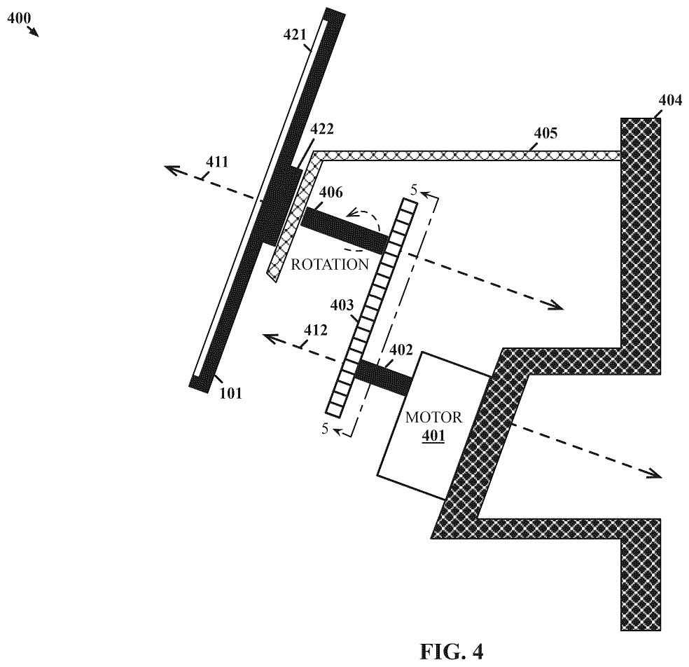

FIG. 4 illustrates implementation 400 for rotating a display system using a motor flexibly connected to the display system. Implementation 400 is like implementation 200 but shows an alternative form of flexible power transmission. Specifically, implementation 400 uses chain 403 as the flexible mechanical power transmitter instead of flexible shaft 203. Chain 403 may be replaced by a belt in some examples. Implementation 400 includes display system 101, motor 401, power output 402, chain 403, cross-vehicle beam 404, bracket 405, power input 406, which are shown from a side profile. It should be understood the shape of the components in implementation 400 is merely exemplary. Display system 101 includes display screen 421 and mounting interface 422. Mounting interface 422 may be part of a housing for display screen 421 in display system 101. Display screen 421 may be a Liquid Crystal Display (LCD), Light-Emitting Diode (LED) display, Organic Light-Emitting Diode (OLED) display, or some other type of display technology. Mounting interface 422 attaches display system 101 to bracket 405. Mounting interface 422 may be attached to bracket 405 using a threaded mechanism, tabs, clips, screws, nuts and bolts, rivets, or some other type of fastener-including combinations thereof. Mounting interface 422 may include one or more bearings enabling display system 101 to rotate around display rotation axis 411, which runs perpendicular to the plane where display system 101 and bracket 405 meet. In some examples, the one or more bearings may be included in bracket 405 where mounting interface 422 connects to bracket 405.

Motor 401 is an electric motor including power output 402. Power output 402 is a shaft with a cog at one end over which chain 403 is installed. Rotational power is provided by motor 401 via power output 402, which rotates around motor rotation axis 412. Motor 401 may be a direct current or alternating current motor. Motor 401 may include one or more bearings, rotor, stator, armature, magnets, brushes, or some other type of component for converting electrical power into mechanical power-including combinations thereof. Power input 406, like power output 402, is a shaft with a cog at one end over which chain 403 is installed. When the cog on power output 402 is turned by motor 401, chain 403 moves and turns the cog on power input 406. power input 406 being connected to display system 101 causes display system 101 to rotate whenever power input 406 is rotated by chain 403. Display rotation axis 411 and motor rotation axis 412 are substantially parallel with one another in this example to ensure chain 403 does not bind when moving. Similarly, the cogs of power input 406 and power output 402 are positioned substantially on the same plane to ensure chain 403 does not bind.

In this example, bracket 405 is affixed to cross-vehicle beam 404 and motor 401 is mounted to cross-vehicle beam 404. Cross-vehicle beam 404 spans vehicle 100 from side to side. Cross-vehicle beam 404 may be located behind a dashboard of vehicle 100 when viewed from the passenger compartment of vehicle 100. Other components of vehicle 100 may also be connected to cross-vehicle beam 404. While motor 401 is directly mounted to cross-vehicle beam 404 is this example, motor 401 may be mounted to a bracket attached to cross-vehicle beam 404 or may be mounted elsewhere in vehicle 100 as long as power output 402 and power input 406 are oriented relative to one another such that chain 403 can move without binding. Additionally, motor 401 is positioned such that motor 401 does not interfere with movement of display system 101 (at least for a predetermined distance) should an impact to display system 101 cause bracket 405 to deform allowing display system 101 to move towards cross-vehicle beam 404.

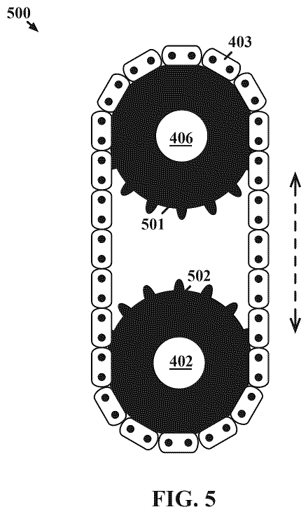

FIG. 5 illustrates chain drive 500 for rotating a display system using a motor flexibly connected to the display system. Chain drive 500 shows chain 403 from a different angle than implementation 400. Specifically, chain 403 is shown from a perspective facing the rear of display system 101. Chain drive 500 includes input cog 501 of power input 406 and output cog 502 of power output 402. Input cog 501 and output cog 502 are the same size in this example, which results in a 1:1 drive ratio. In other examples, input cog 501 and output cog 502 may be different sizes to create different drive ratios. A distance between input cog 501 and output cog 502 may be chosen such that chain 403 can flex in response an impact force to display system 101, as described in operational scenario 600 below. When power output 402 rotates output cog 502, chain 403 moves as well. When chain 403 moves input cog 501 of power input 406 is moved to rotate display system 101.

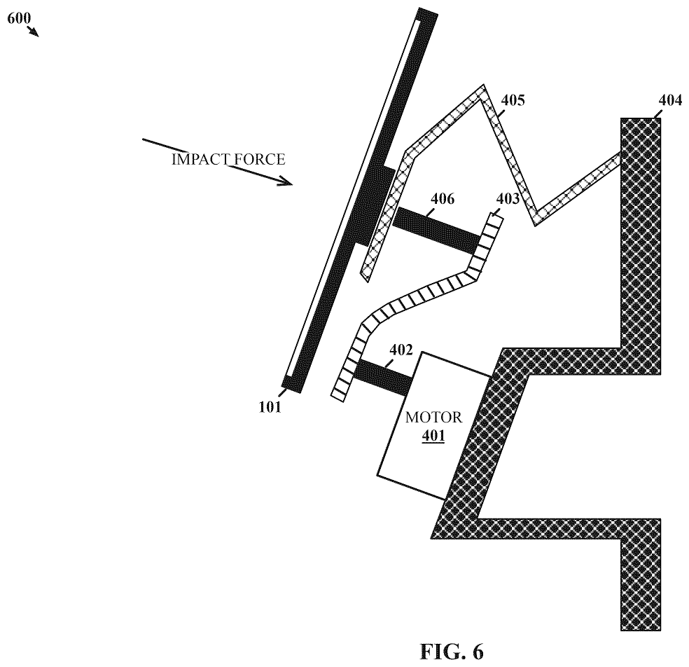

FIG. 6 illustrates operational scenario 600 for a display system rotatable using a motor flexibly connected to the display system. Operational scenario 300 is an example of what may happen with the components of implementation 400 should an impact force be applied to display system 101. The direction of the impact force on display system 101 is substantially towards cross-vehicle beam 404, as the impact force may be coming from an impact of a passenger of vehicle 100 on display system 101 (e.g., a passenger's head to impacting display system 101 during a front-end collision).

Bracket 405, in this example, is designed to collapse, crush, or otherwise deform upon an impact force being transmitted to bracket 405 from display system 101. The amount of force absorbed by display system 101 and bracket 405 may be linear or progressive. The shape of bracket 405 may be dependent upon an amount of force intended to be absorbed, packaging considerations within vehicle 100, a material (e.g., metal, plastic, etc.) from which bracket 405 is constructed, or some other characteristic. Given that motor 401, like motor 201, is not mounted to bracket 405, bracket 405 may be a bracket originally designed to handle non-rotatable display systems.

In operational scenario 600, bracket 405 has bent at multiple locations to absorb the impact force applied to display system 101. Space still remains between display system 101 and motor 401 but the distance between display system 101 and motor 401 is smaller than the distance prior to impact, as shown in implementation 400. The state of bracket 405 in operational scenario 600 is merely an example of how bracket 405 may crush in response to the impact force. As noted above, bracket 405 may take different shapes and be made of different materials, which may result in different reactions by bracket 405 to receiving the impact force. The flexibility chain 403 enables chain 403 to bend when input cog 501 and output cog 502 become misaligned due to the collapsing of bracket 405 from the impact force. Preferably, the flexibility of chain 403 is enough such that the presence of chain 403 has a negligible effect on impact absorption characteristics of bracket 405. In some examples, if chain 403 is flexed beyond a threshold amount of deflection, chain 403 may be designed to pop off of input cog 501 and/or output cog 502 or may break (e.g., a link in chain 403 may fail) before appreciably affecting the impact force absorption characteristics of bracket 405. Likewise, motor 401 is positioned such that motor 401 does not interfere with movement of display system 101 or bracket 405 for at least a predefined amount of movement when an impact for is experienced by display system 101. The amount of movement may be based on safety regulations or other passenger safety requirements. Like with the flexible shaft example above, the flexibility of chain 403 and the positioning of motor 401 allows bracket 405 to crumple as designed in contrast to what may occur with a rigid shaft or direct motor mounting.

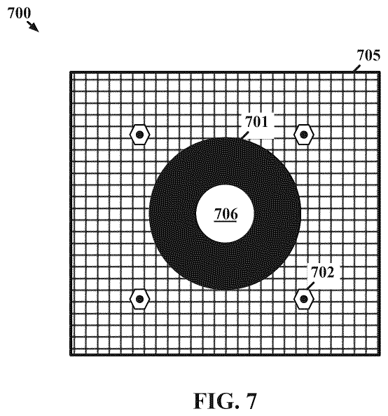

FIG. 7 illustrates mounting connection 700 for rotating a display system using a motor flexibly connected to the display system. Mounting connection 700 includes mounting interface 701, bracket face 705, four mounting fasteners 702, and power input 706. Mounting interface 701 is an example of mounting interface 422 or mounting interface 222 for mounting display system 101. Bracket face 705 is an example of a face of bracket 205 or bracket 405 to which mounting interface 222 or mounting interface 422 connects. As such, mounting connection 700 is shown from a perspective facing the rear of display system 101. Bracket face 705 includes an opening through which mounting interface 701 can be seen and through which power input 706 passes. Power input 706 is an example of power input 206 or power input 406. In some examples, a portion of mounting interface 701 may also pass through bracket face 705. While the opening is round in this example, the opening in other examples may take different shapes.

Mounting interface 701 in this example includes four mounting fasteners 702 positioned around the opening. Mounting fasteners 702 may be bolts placed through holes in bracket face 705 and mounting interface 701 before being secured by nuts. Other examples may use more or fewer fasteners than the four shown in mounting connection 700. In some examples mounting interface 701 may thread into the opening in bracket face 705. Other manners of connecting mounting interface 701 to bracket face 705 may be used in other examples. Mounting interface 701 includes components, such as a bushing or bearing, that enables power input 706 to rotate along with the rest of display system 101 connected to power input 706. In some examples, mounting interface 701 may include a component (e.g., a retaining pin) that prevents display system 101 from rotating when no mechanical power transmitter (e.g., shaft, chain, or belt drive) is connected to power input 706 or power input 706 is absent.

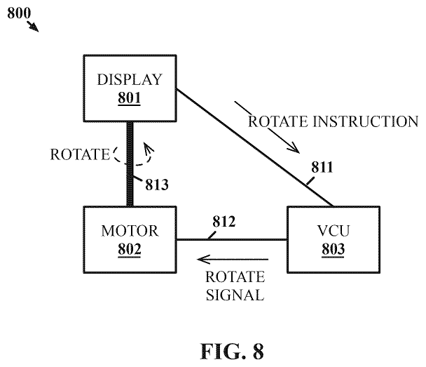

FIG. 8 illustrates implementation 800 for rotating a display system using a motor flexibly connected to the display system. Implementation 800 includes display system 801, motor 802, vehicle compute unit (VCU) 803, and flexible mechanical power transmitter 813. Display system 801 is an example of display system 101, motor 802 is an example of motor 201 or motor 401, and flexible mechanical power transmitter 813 is an example of flexible shaft 203 or chain 403. Display system 801 and VCU 803 communicate over communication link 811. Motor 802 and VCU 803 communicate over communication link 812. Communication links 811-812 may be direct links or may include intervening systems, networks, or devices.

VCU 803 is a processor-based computing system that is at least tasked with controlling rotation of display system 801. VCU 803 may handle other vehicle tasks as well. VCU 803 includes a communication interface for communication links 811-812. The communication interface may also handle other communication links with VCU 803. VCU 803 may also include circuitry for connecting to sensors or other types of vehicle components (e.g., buttons, other motors, other displays, driver assistance systems, etc.). In some examples, VCU 803 may be one of multiple VCUs that each handle at least a portion of the tasks for vehicle 100.

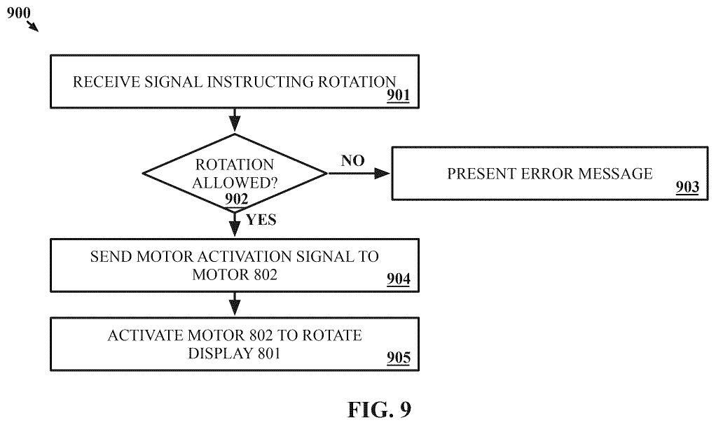

FIG. 9 illustrates operation 900 to rotate a display system using a motor flexibly connected to the display system. In operation 900, VCU 803 receives a signal from display system 801 instructing VCU 803 to rotate display system 801 (step 901). The signal may represent user input received from a user via display system 801. For example, a software button displayed by display system 101 to give the user an option to rotate display system 801 may be triggered by the user and cause the signal to be sent to VCU 803. The signal need not be received from display system 801 in all examples. In some examples, a physical button or switch, either on display system 801 or elsewhere in vehicle 100, may be activated by the user. In further examples, the signal may include information received by VCU 803 about vehicle 100 and the information may trigger VCU 803 to rotate display system 801 automatically upon condition(s) being satisfied. For example, VCU 803 may receive a signal indicating vehicle 100 has been taken out of park (e.g., into drive or reverse). VCU 803 may be configured to ensure display system 801 is in a particular orientation when not in park and may, therefore, trigger rotation of display system 801 if vehicle 100 is not in the configured orientation.

After receiving the signal, VCU 803 determines whether rotation is allowed (step 902). VCU 803 may maintain a set of conditions in which display system 801 cannot be in one orientation or the other, or conditions in which display system 801 should not be in motion regardless of orientation. Using the park example above, VCU 803 may be configured to maintain display system 801 in a portrait orientation when not in park. If the received signal is requesting a rotation into landscape while vehicle 100 is not in park, then VCU 803 will not perform the screen rotation. Optionally, VCU 803 may present an error message to inform the user that display system 801 cannot be rotated (step 903). For instance, VCU 803 may send a signal back to display system 801 to display a message to the user and/or send a signal to an audio system of vehicle 100 to play an audible alert to the user. In some examples, rotation may be allowed in all circumstances and step 902 can be skipped.

If screen rotation is allowed, VCU 803 sends a motor activation signal to motor 802 (step 904) and motor 802 activates to rotate display system 801 in response to the signal (step 905). Motor 802 may include processing circuitry to process and carryout instructions from VCU 803. For instance, the signal may direct motor 802 to rotate and the circuitry in motor 802 may carry out that instruction on its own until display system 801 is in the desired orientation. In another example, the signal may turn on motor 802 and VCU 803 may send another signal directing motor 802 to stop (e.g., a sensor on display system 801 may detect when the desired orientation is reached and provide a feedback signal to VCU 803 triggering VCU 803 to stop motor 802). In other examples, communication link 812 may be a power supply line to motor 802. In those examples, the signal from VCU 803 comprises power to motor 802, which causes motor 802 to rotate. A physical stopper or sensor at display system 801 may indicate to VCU 803 when display system 801 has reached the desired orientation.

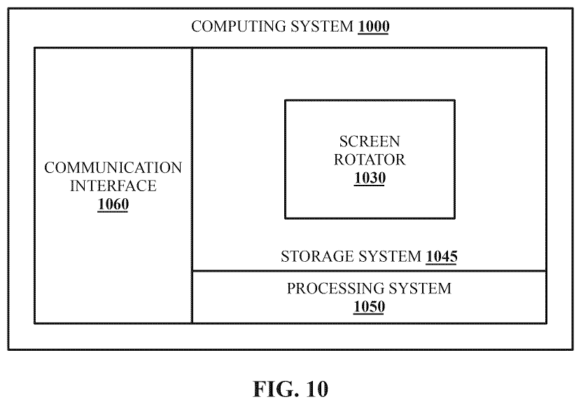

FIG. 10 illustrates computing system 1000 for rotating a display system using a motor flexibly connected to the display system. Computing system 1000 is an example architecture for VCU 803. Computing system 1000 includes storage system 1045, processing system 1050, and communication interface 1060. Processing system 1050 is operatively linked to communication interface 1060 and storage system 1045. Communication interface 1060 may be communicatively linked to storage system 1045 in some implementations. Computing system 1000 may further include other components such as a battery and enclosure that are not shown for clarity.

Communication interface 1060 comprises components that communicate over communication links, such as network cards, ports, radio frequency (RF), processing circuitry and software, or some other communication devices. Communication interface 1060 may be configured to communicate over metallic, wireless, or optical links. Communication interface 1060 may be configured to use Time Division Multiplex (TDM), Internet Protocol (IP), Ethernet, optical networking, wireless protocols, communication signaling, or some other communication format—including combinations thereof.

Processing system 1050 comprises microprocessor and other circuitry that retrieves and executes operating software from storage system 1045. Storage system 1045 may include volatile and nonvolatile, removable, and non-removable media implemented in any method or technology for storage of information, such as computer readable instructions, data structures, program modules, or other data. Storage system 1045 may be implemented as a single storage device but may also be implemented across multiple storage devices or sub-systems. Storage system 1045 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no examples would storage media of storage system 1045, or any other computer-readable storage medium herein, be considered a transitory form of signal transmission (often referred to as “signals per se”), such as a propagating electrical or electromagnetic signal or carrier wave.

Processing system 1050 is typically mounted on a circuit board that may also hold the storage system. The operating software of storage system 1045 comprises computer programs, firmware, or some other form of machine-readable program instructions. The operating software of storage system 1045 comprises screen rotator 1030. The operating software on storage system 1045 may further include an operating system, utilities, drivers, network interfaces, applications, or some other type of software. When read and executed by processing system 1050 the operating software on storage system 1045 directs computing system 1000 to control a motor that rotates a display system. Screen rotator 1030 may execute natively on processing system 1050 or the operating software may include virtualization software, such as a hypervisor, to virtualize computing hardware on which screen rotator 1030 executes.

In an example, screen rotator 1030 directs processing system 1050 to receive a signal instructing processing system to rotate a display system and transmit a rotation signal directing a motor to rotate the display system. In response to the rotation signal, the motor, which is connected to a flexible mechanical power transmitter, rotates the display system around a screen-rotation axis. Power output of the motor rotates around a motor-rotation axis different from the screen-rotation axis.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. An apparatus for a motorized rotation of a display in a vehicle, the apparatus comprising:
a display system including a display screen on a front side of the display system and a mounting interface on a rear side of the display system;
a bracket to which the mounting interface attaches;
a flexible mechanical power transmitter connecting a power output of a motor to a power input at the mounting interface, wherein the flexible mechanical power transmitter rotates the display system around a screen-rotation axis; and
the motor including the power output, wherein the power output rotates around a motor-rotation axis different from the screen-rotation axis.

2. The apparatus of claim 1, wherein the flexible mechanical power transmitter comprises a flex shaft.

3. The apparatus of claim 2, wherein the flex shaft comprises braided wire.

4. The apparatus of claim 1, wherein the power output comprises an output gear and the power input comprises an input gear, and wherein the flexible mechanical power transmitter comprises a chain engaging the output gear and the input gear.

5. The apparatus of claim 4, wherein the output gear rotates around a motor-rotation axis substantially parallel to the screen-rotation axis.

6. The apparatus of claim 1, wherein the power output comprises an output pulley and the power input comprises an input pully, and wherein the flexible mechanical power transmitter comprises a belt engaging the output pulley and the input pulley.

7. The apparatus of claim 1, wherein the motor is mounted to a cross-vehicle beam within a dash of the vehicle.

8. The apparatus of claim 7, wherein the bracket is mounted to the cross-vehicle beam.

9. The apparatus of claim 1, wherein the bracket is configured to buckle when the display system is impacted from the front side while still providing clearance between the display system and the motor.

10. The apparatus of claim 1, wherein the flexible mechanical power transmitter deforms from an operating position when the display system is impacted from the front side.

11. The apparatus of claim 1, wherein the motorized rotation is limited to rotating the display between a portrait orientation and a landscape orientation.

12. A method for rotating a display system in a vehicle, the method comprising:
transmitting, from a vehicle compute unit, a rotation signal directing a motor to rotate the display system; and
at the motor, in response to the rotation signal, activating the motor connected to a flexible mechanical power transmitter to rotate the display system around a screen-rotation axis, wherein power output of the motor rotates around a motor-rotation axis different from the screen-rotation axis.

13. The method of claim 12, comprising:
receiving, in the vehicle compute unit, user input requesting the display system be rotated, wherein the rotation signal is transmitted in response to the user input.

14. The method of claim 12, wherein the rotation signal comprises electrical power to power the motor.

15. The method of claim 12, wherein the rotation signal comprises an instruction to power the motor.

16. The method of claim 12, wherein activating the motor rotates the display system between a portrait orientation and a landscape orientation.

17. An apparatus for a motorized rotation of a display in a vehicle, the apparatus comprising:
a display mounted to a bracket;
a cross-vehicle beam;
the bracket attached to the cross-vehicle beam; and
an interface between the bracket and the display, wherein the interface allows the display to rotate when connected to a flexible mechanical power transmitter connecting a power output of a motor to the display.

18. The apparatus of claim 17, comprising:
the motor attached to the cross-vehicle beam; and
the flexible mechanical power transmitter.

19. The apparatus of claim 17, wherein the interface prevents the display from rotating when not connected to a flexible mechanical power transmitter.

20. The apparatus of claim 17, wherein the bracket is designed to collapse upon receiving a specified impact force.
